(19) United States
(12) Patent Application Publication
(10) Pub. No.: US 2013/0016875 A1
(43) Pub. Date: Jan. 17, 2013

(54) METHOD, APPARATUS, AND COMPUTER PROGRAM PRODUCT FOR GENERATION OF TRACEABILITY MATRICES FROM VIDEO MEDIA

(71) Applicant: Naoufel Boulila, Munchen (DE)

(72) Inventor: Naoufel Boulila, Munchen (DE)

(21) Appl. No.: 13/180,820

(22) Filed: Jul. 12, 2011

(51) Int. Cl. G06K 9/00; G06F 9/44

(52) U.S. Cl. 382/103; 717/120

(57) ABSTRACT

A method, apparatus and computer program product for generating a traceability matrix document regarding a system under development, provides for: providing input information regarding the system under development to a processing framework, processing the input information by the processing framework, and automatically creating a traceability matrix document regarding the system under development from the input information.

### TECHNICAL FIELD

The present invention is directed to a method, apparatus, and computer program product for the generation of traceability matrices from video media. Specifically, the present invention is directed to means and methods for the automatic generation of a traceability matrix from system requirements information presented as video media.

### BACKGROUND

Successful requirements management projects include traceability as one of their most important activities. The work product of a successfully carried out traceability effort is a traceability matrix, that, as currently known in the art, is presented as a document, usually in the form of a table, that correlates any two baseline documents that require a many-to-many relationship to determine the completeness of a relationship between two components of a technical system. The traceability matrix is used with high-level requirements (such as marketing requirements), and the detailed requirements of the software embedded in the technical system to be built for the high-level design, the detailed design, the development of a test plan, and the performance of test cases for the technical system that is to be built.

A requirements traceability matrix is currently used to check if the current project requirements are being met, and to help with the creation of requests for proposal, various deliverable documents, and project plan tasks. Common usage for a requirements traceability is to take an identifier for each of the items of one document and place them in a left column of the matrix. The identifiers for the other document are placed across the top row of the matrix. When an item in the left column of the matrix is related to an item across the top, a mark is placed in the intersecting cell. The number of relationships is added up for each row and each column. This value indicates the mapping of the two items. Zero values indicate that no relationship exists. It must be determined if one must be made. Large values imply that the relationship is too complex and should be simplified. To ease the creation of traceability matrices, currently the relationships to the source documents are added for both backward traceability and forward traceability. In other words, when an item is changed in one baseline document, it's easy to see what needs to be changed in the other.

Requirements traceability refers to a sub-discipline of requirements management within software development and systems engineering. Requirements traceability is concerned with documenting the life of a requirement and to provide bi-directional traceability between various associated requirements. It enables users to find the origin of each requirement and track every change which was made to this requirement. For this purpose, it may be necessary to document every change made to the requirement. Requirements traceability refers to the ability to describe and follow the life of a requirement, in both forward and backwards direction (i.e. from its origins, through its development and specification, to its subsequent deployment and use, and through all periods of on-going refinement and iteration in any of these phases.)

While the current understanding regarding requirements traceability emphasizes tracking the life of a requirement through all phases of development, it is not explicit in mentioning that traceability may document relationships between many kinds of development artifacts, such as requirements, specification statements, designs, tests, models and developed components.

In order to fully characterize the system under development, the requirements traceability must refer as well to the ability to define, capture and follow the traces left by requirements on other elements of the software development environment and the trace left by those elements on requirements.

In the requirements engineering field, traceability is about understanding how high-level requirements, objectives, goals, aims, aspirations, expectations, needs, are transformed into low-level requirements. Traceability if therefore primarily concerned with the relationships between the layers of information.

The principal relationship referred to here may be characterized as “satisfaction”: how is a requirement satisfied by other artifacts? Other relationships that can be traced are, for example, “verification”: how is a requirement verified by test artifacts?

In the classical requirements management projects, the traceability matrix documents are written manually. The underlined activity of populating the matrix and maintaining the document proves to be hard to conduct, especially for projects that involve the extraction of information from large requirements specifications. Many hours of man power are invested into manually creating the traceability matrix.

### SUMMARY

Therefore, what are needed are solutions that aid with the automatic creation of the traceability matrices, without compromising the granularity of the information captured in the matrix.

According to various embodiments, a method of generating a traceability matrix document regarding a system under development, may comprise: providing input information regarding the system under development to a processing framework; processing said input information by said processing framework, and automatically creating a traceability matrix document regarding the system under development from said input information.

According to a further embodiment, said input information can be provided via video media. According to a further embodiment, the method may further comprise the step of annotating said video media. According to a further embodiment, said input information regarding the system under development may define the components of the system under development needed for the generation of the traceability matrix document regarding the system under development. According to a further embodiment, said input information may comprise both early system requirements information and high-level system requirements information. According to a further embodiment, the step of processing said input information may comprise extracting at least one of a plurality of requirements traces from said annotated video media, a plurality of requirements regarding the system under development, and the identification of a plurality of objects of interest comprised by the system under development. According to a further embodiment, the step of processing said input information presented as video media may comprise the identification in said video media of at least a scene of interest, and the identification of a plurality of frames of interest within said identified scene. According to a further embodiment, the step of processing said input information presented as video media further may comprise identifying in said plurality of frames of interest a plurality of objects of interest, and wherein said frames of interest each comprise a diagram. According to a further embodiment, said diagram can be at least one of a requirements model diagram (UML diagram), a system requirements diagram, or a combination of the two diagrams. According to a further embodiment, the step of processing said input information presented as video media may further comprise identifying a plurality of traces between the identified plurality of objects of interest in said frame of interest. According to a further embodiment, the step of automatically creating a traceability matrix document may involve processing at least one of plurality of requirements traces from said annotated video media, a plurality of requirements regarding the system under development, and a plurality of objects comprised by the system under development. According to a further embodiment, the method may further comprise extracting a plurality of requirements models for the objects located in a frame of interest. According to a further embodiment, the method may further comprise mapping the extracted components of said input information to create the traceability matrix document regarding the system under development.

According to another embodiment, an apparatus for generating a traceability matrix document regarding a system under development, may comprise means for providing input information regarding the system under development to a processing framework; means for processing said input information by said processing framework, and means for automatically creating a traceability matrix document regarding the system under development from said input information.

According to yet another embodiment, a computer program product, may comprise a tangible computer usable medium including a computer usable program code for generating a traceability matrix document regarding a system under development, the computer usable program code for: providing input information regarding the system under development to a processing framework; processing said input information by said processing framework, and automatically creating a traceability matrix document regarding the system under development from said input information.

### BRIEF DESCRIPTION OF THE DRAWINGS

In order to assist the understanding of embodiments, reference will now be made to the appended drawings, in which like reference numerals refer to like elements. The drawings are exemplary only, and should not be construed as limiting the invention.

FIG. 1 is a flowchart representation of a method of generating a traceability matrix document regarding a system under development, in accordance with an embodiment.

FIG. 2 is a schematic representation of a processing framework in accordance with various embodiments.

FIG. 3 illustrates an exemplary structure for a requirement analysis video.

The accompanying drawings are included to provide a further understanding of embodiments. The drawings illustrate embodiments and together with the description serve to explain the principles of said embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts. Features of the various exemplary embodiments described herein may be readily combined with each other, unless specifically noted otherwise.

### DETAILED DESCRIPTION

According to various embodiments, a method of generating a traceability matrix document regarding a system under development, may comprise: providing input information regarding the system under development to a processing framework, processing the input information by the processing framework, and automatically creating a traceability matrix document regarding the system under development from said input information.

The input information is provided via video media. The input information regarding the system under development defines select parts of the system under development needed for the generation of the traceability matrix document regarding a system under development. The input information comprises both early system requirements information and high-level system requirements information.

The method of generating a traceability matrix document according to various embodiments further comprises annotating the video media.

The step of processing the input information involves extracting at least one of a plurality of requirements traces from the annotated video media, and a plurality of requirements regarding the system under development, and the identification of a plurality of objects of interest comprised by the system under development. The step of processing the input information presented as video media also comprises the identification in the video media of a scene of interest, and the identification of a plurality of frames of interest within the identified scene. The step of processing the input information presented as video media further comprises identifying in the plurality of frames of interest a plurality of objects of interest, wherein the frames of interest each comprise a diagram. The diagram is at least one of a requirements model diagram (UML diagram), and a system requirements diagram. The step of processing the input information presented as video media further comprises identifying a plurality of traces between the identified pluralities of objects of interest in the frame of interest.

The step of automatically creating a traceability matrix document involves processing at least one of plurality of requirements traces from the annotated video media, a plurality of requirements regarding the system under development, and a plurality of objects comprised by the system under development.

The method of generating a traceability matrix further comprises extracting a plurality of requirements models for the objects located in a frame of interest. The method of generating a traceability matrix document further yet comprises mapping the extracted components of the input information to create the traceability matrix document regarding the system under development.

In accordance with a further embodiment, an apparatus for generating a traceability matrix document regarding a system under development may comprise means for providing input information regarding the system under development to a processing framework, means for processing the input information by said processing framework, and means for automatically creating a traceability matrix document regarding the system under development from the input information.

In accordance with yet a further embodiment a computer program product may comprise a tangible computer usable medium including a computer usable program code for generating a traceability matrix document regarding a system under development, the computer usable program code for providing input information regarding the system under development to a processing framework, processing the input information by the processing framework, and automatically creating a traceability matrix document regarding the system under development from the input information.

In this description, reference is made to a “traceability matrix document”. In accordance with the meaning associated in the present document, a traceability matrix document represents a table that traces the requirements to the system deliverable component for that stage that responds to the requirement. The use of a traceability matrix document is to validate the compliance of a process or product with the requirements for that process or product. The requirements are each listed in a row of the matrix and the columns of the matrix are used to identify how and where each requirement has been addressed.

Requirements traceability is concerned with documenting the life of a requirement and to provide bi-directional traceability between various associated requirements. It enables users to find the origin of each requirement and track every change which was made to this requirement. For this purpose, it may be necessary to document every change made to the requirement.

Requirements traceability includes tracing to various artifacts that satisfy the requirements such as capabilities, design elements, manual operations, test, etc. The traceability matrix is used to document the relationships which prove useful in ensuring that all requirements are met and to locate affected system components when requirements change. In large scale protects, where the complexity of these many-to-many relationships is high, it is particularly difficult to produce the traceability matrix document and to maintain it. The automation of this process makes the development and maintenance of the requirements and the underlined system components easier and more cost-effective.

By video annotation is understood the task of associating graphical objects with moving objects on a screen.

The video annotation may be carried out via a Unified Modeling Language (UML) that is a standardized general-purpose modeling language in the field of object-oriented software engineering. UML includes a set of graphic notation techniques to create visual models of object-oriented software-intensive systems. The Unified Modeling Language (UML) is used to specify, visualize, modify, construct and document the artifacts of an object-oriented software-intensive system under development. UML offers a standard way to visualize a system's architectural blueprints, including elements such as: activities, actors, business processes, database schemas, logical components, programming language statements, reusable software components.

UML combines techniques from data modeling (entity relationship diagrams), business modeling (work flows), object modeling, and component modeling. UML models may be automatically transformed to other representations (e.g. Java) by means of QVT-like transformation languages.

According to various embodiments, it is proposed to use information regarding a system under development that is presented via video media. The various embodiments provide a method that enables the automatic generation of the traceability matrix document directly from the requirements analysis video.

The video includes annotated objects or superimposed system models, such as UML or scenes from the real world. The scenes may exemplarily depict the interaction of a user with the technical system under development or the system desired to be in the future developed. Such videos are used in many research prototypes, such as the VBRE framework, as well as in commercial multimedia products for collaborative brainstorming and system design.

Exemplarily, a client has imagined and digitally created a video material regarding a desired airport employee access and monitoring facility. Such a video material among others illustrates the interaction between an alleged airport employee and the desired facility. Exemplarily the video may show that the user approaches a gate provided with a scanning device over which the user passes its hand. As a result the user's fingerprint is scanned and the user is authenticated via a computer, as well visible in the video. The results of the authentication are displayed on the computer screen and should the authentication be positive the gate opens and the user is granted access into the airport facility.

The desired airport employee access and monitoring facility is the exemplary technical system that the client is commissioning a team of engineers to develop and for this purpose, a specification requirements document and a traceability matrix need to be developed using the information presented in the video. Of course the above example is only one of the many possible scenarios of systems that may have a virtual or real video representation, and the present invention is not restricted to the example provided above.

In order to develop the specification requirements document and the traceability matrix, means and methods for the automated generation of the traceability matrix document regarding the system under development are proposed.

In accordance with a method proposed by one embodiment, the method of generating a traceability matrix document regarding a system under development comprises at least the steps of providing input information regarding the system under development to a processing framework, processing the input information by the processing framework, and automatically creating a traceability matrix document regarding the system under development from the input information.

In the following, the above referenced method will be described in connection with the illustration of the figures.

FIG. 1 is a flowchart representation of a method of generating a traceability matrix document regarding a system under development, in accordance with an embodiment.

Method 100 for generating a traceability matrix document regarding a system under development comprises at least the steps of providing 102 input information regarding the system under development to a processing framework, processing 104 the input information by the processing framework, and automatically creating 106 a traceability matrix document regarding the system under development from the input information.

The step 102 of providing input information regarding the system under development to a processing framework involves providing the input information regarding the system to be developed via video media. Of course, a person skilled in the art would be aware that the input information may also be provided via other media, such as photography, computer generated schematics or designs and any other representation apparent to a person skilled in the art. The video media may illustrate existing technical systems that are means to be improved, or virtual reality regarding systems that have been digitally conceived and they are to be reduced to practice. The video media is annotated, for example with the aid of an UML language to create a requirements analysis video regarding the system to be developed. Of course any other suitable software techniques apart from URL may be used to annotate the video material, techniques that are capable of mapping the video with the software requirements.

During step 102 may also be defined which parts of the system to be developed are needed to be analyzed in order to generate the traceability matrix. High-level requirements that are related to the early requirements definitions are not linked, and that are not necessarily related to a physical system shown in a scene, could also be extracted. The input information comprises both early system requirements information and high-level system requirements information.

The Requirement Analysis Video means stores the requirements analysis video and as such all the necessary information regarding a scene, a frame, an object in a scene, an UML element, a requirement object, and a requirement trace element. The requirement analysis video is in its simplest form a succession of annotated video-frames superimposed with the elements of an UML requirements model, such as use cases and activity diagrams.

The step of processing the input information 104 by the processing framework comprises a plurality of sub-steps regarding both the processing of the video material and of the information comprised in the video material.

The processing framework in accordance with various embodiments is capable of location transformation, to locate in the annotated video all the objects of interest in a specific scene or frame. Further, the processing framework is capable of identifying traces between the elements of interest. By elements of interest in understood . . . The traces are logical relationships that connect the physical objects represented in the video with their requirements relationship. Even for the simple example provided above regarding the desired facility of monitoring airport employee access, a very long list of system requirements will be identified, list of requirements that may be collected either top up or top down.

During the processing step the elements of the system are identified and extracted. Traces are assumed to exist between all the extracted elements. The number of identified traces is as well large even for simple systems, such as the exemplary system. As such, from the total number of ways to logically interrelate the identified elements, only those that lead to the development of the desired product are selected, and the rest are discarded for the purposes of processing.

The processing also involves locating in the scene the objects that are needed for the purpose of developing the technical system and finding the relationships or traces only between the different elements of interest.

During the processing step information is also gathered regarding the video itself, and said video is divided as applicable in scenes, frames within the scenes, applied diagrams for each frame and the objects of interest in each frame. Further, all applicable traces are as well extracted regarding an object of interest in a particular frame.

Of course it is possible during the processing phase to extract automatically all traces, but the result may be a requirements/traceability document that shows a large number of traces that are not related physically or are not correct. Automatically tracking the object within the frame, then within a scene and then through the entire video, or track the object relationship with the other objects in each one of the frames, scenes and the entire video leads to a large amount of information to be included in the traceability matrix, not specifically related to the technical system desired to be developed. Therefore, some of the identified traces in this configuration need to be eliminated as irrelevant.

Therefore, to summarize, the method of generating a traceability matrix document of involves extracting at least one of a plurality of requirements traces from the annotated video media, extracting a plurality of requirements regarding the system under development, and extracting information regarding a plurality of objects comprised by the system under development.

The step of processing the input information presented as video media comprises the identification in the video media of a scene of interest, and the identification of at least a frame of interest within the identified scene. Further, in the frame of interest a plurality of objects of interest are as well identified. Each frame of interest comprises a diagram. The diagram is at least one of a requirements model diagram (UML diagram), and a system requirements diagram. The step of processing the input information presented as video media further comprises identifying a plurality of traces between the identified plurality of objects of interest in the frame of interest.

Once all the required input information is identified, such as the frame of interest, the objects of interest located in the frame of interest, and the traces connecting the object of interest with other objects of interest, further input information will be identified by tracing the object of interest from frame to frame and observing again its traces with other objects of interest in subsequent frames. A plurality of requirements models are extracted for the objects located in a frame of interest and from the object being located in subsequent, consecutive or non consecutive frames. The extracted components are mapped to create in step 106 the traceability matrix document regarding the system under development or intended to be developed.

In accordance with one of its embodiments, an apparatus for generating a traceability matrix document regarding a system under development may comprise means for providing input information 202 regarding the system under development to a processing framework, means for processing 204 the input information by the processing framework, and means for automatically creating 206 a traceability matrix document regarding the system under development from the input information.

A processing framework 208 is, in accordance with various embodiments, envisioned as comprising an input component 210, a location component 212, a transformation component 214, and an output component 216.

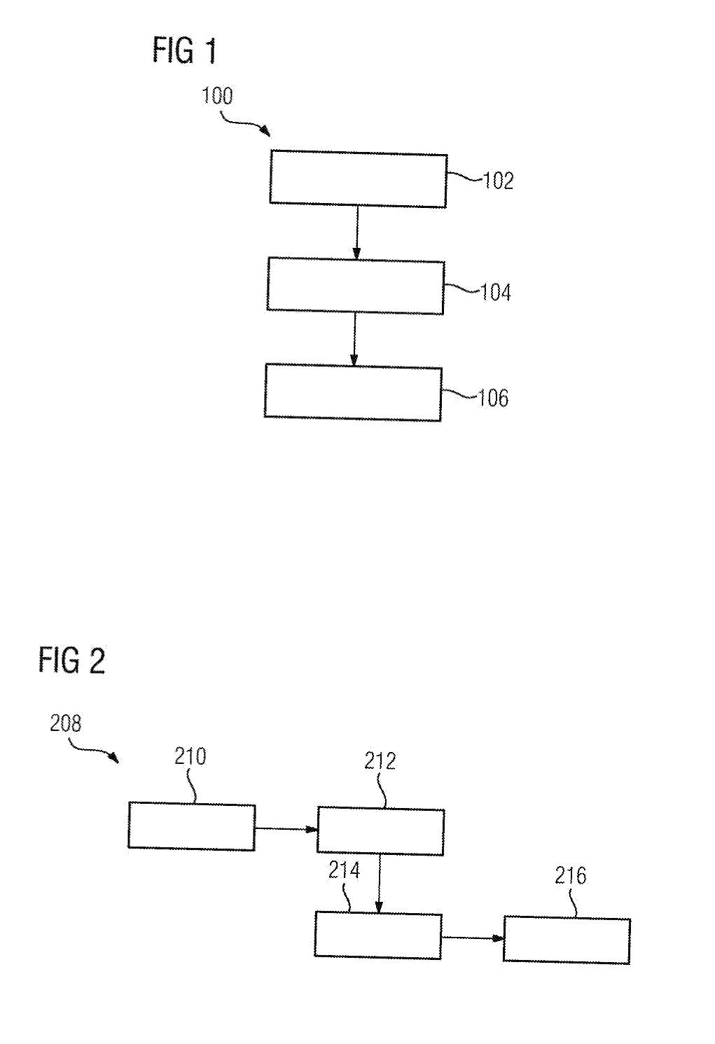

FIG. 2 is a schematic representation of a processing framework 208 in accordance with various embodiments.

In accordance with various embodiments the processing framework may be implemented via input means 210 that define what parts of the system under development are needed to generate the traceability matrix. High-level requirements are related to the early requirements definitions of the system are not linked necessarily to the physical system, shown in an actual video scene, and they may as well be extracted.

The processing framework 208 may also comprise a location means 212 that are capable of locating the frame or scene in the requirements analysis video, such as where the specific system components are shown in the video. The corresponding requirements models are already superimposed on the video.

The processing framework 208 may also comprise transformation means 214 that are capable of extracting the required models located in the requirements analysis video, and the corresponding system components from the video. Mapping is then required to the physical components of the system.

The processing framework 208 may also comprise an output means 216 that are capable of documenting and generating a document showing the relationship matrix.

For an exemplary requirements analysis video, in accordance with various embodiments, the objects of interest are defined. For the system illustrated in the video the requirements specification is created and test cases need to be performed for each requirement. It is therefore insured that the right system is built and not another system that is not required. In short, the system's requirements are optimized. Every feature identified for a system to be built has to be connected to a need and this connection is indicated by a trace. Should a direct trace be absent between an element of the system and a requirement for the system, it is likely that the wrong system is being developed. Therefore, it is important that the represented traces are correct. As discussed previously, in accordance to the knowledge available in the art traces are collected manually or semi-manually starting from large paper specifications that specify thousands of requirements for complex system. The likelihood that a trace might be misplaced or lost between a system element and a requirement is large leading therefore to the development of an incorrect system.

This situation, and the expenditure of the large effort of time is avoided when practicing the method according to various embodiments, since when starting from a digital video that is actually a requirements analysis video where the requirement model has been annotated on the digital video, the generation of the accurate traces and of a correct traceability matrix is performed automatically.

During the processing phase of the method according to various embodiments, all the components in the video are located in connection with a position in the frame within the video. Their location may be defined with the aid of a time stamp or with the aid of known techniques that allow the video to be broken down frame by frame. The object of interest is tracked down frame by frame throughout the video. Of course, in each frame the object of interest interacts with other objects. Further, the objects may change the nature of their interaction as they move from frame to frame. As such they have a dynamical relationship that has to be characterized via the correct traces. Therefore, a selection is made as to where in the video clip at what frame is the object of interest located. Further, the object of interest is located in all the available frames within the video, if applicable. From this information the relationship is derived between all the objects involved in the analysis and all the applicable traces are derived. The information is then transferred and transformed in the applicable traceability matrix.

Each one of the elements of the processing framework 208, the input component/means 210, the location component/means 212, the transformation component/means 214, and the output component/means 216 are involved in the performance of the step of processing the input information by said processing framework.

The location component 212 is capable of aiding with the identification of the object location in various frames and the breakdown of the video in various frames. Within each frame the object of interest is identified and the relationship of the elements and the relationship between the elements is as well identified. Traces are created between the objects. The traces are connected to higher requirements of the system. The object of interest is followed from video frame to video frame of interest and the steps mentioned above are repeated for each frame. The transformation means 214 receives the collected traces and generates with the aid of the output means 216 the required traceability matrix between the elements of the system under development.

As mentioned several times in this document it is a prerequisite for various embodiments that the video material employed is a digital video material. The requirements analysis video is a digital video that has a superimposed UML model.

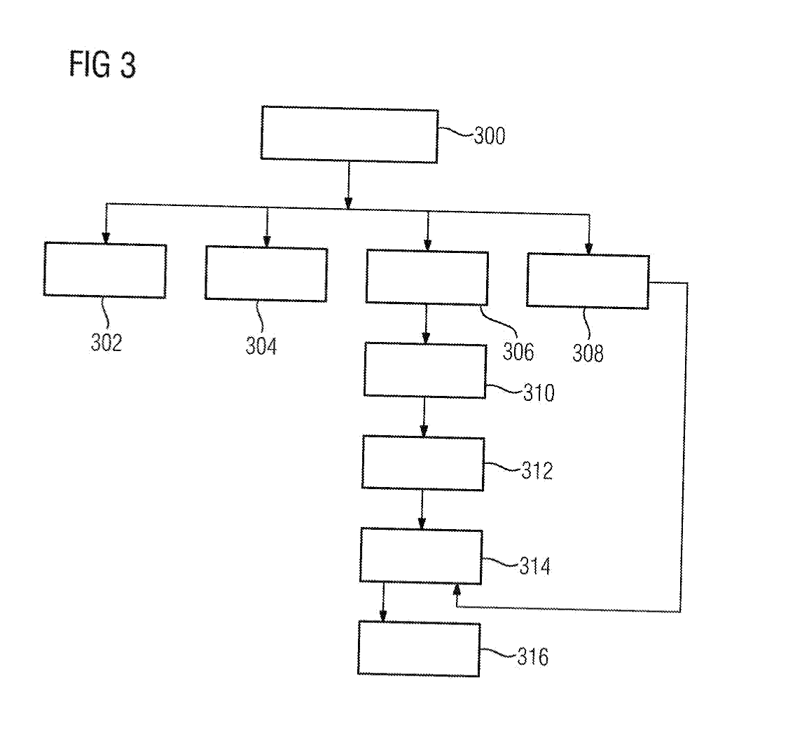

FIG. 3 illustrates an exemplary structure for a requirement analysis video.

The requirements analysis video 300 illustrated in FIG. 3 is characterized by containing information regarding a scene or scenes 302 within the video, a frame or frames of the video 304, objects 306 in the scenes or frames, and comprises an annotation 308, a diagram that may be an UML diagram 310, a requirements diagram 312, or a combination of the two. Further, diagram 306 is characterized by the elements 314 of said requirements diagram 312. Via traces 316 the object or objects 308 may be connected to the requirement elements 314.

As mentioned above, various embodiments may as well be implemented via computer software that is capable of performing the method. Therefore, in accordance with a further embodiment is proposed a computer program product capable of generating a traceability matrix document regarding a system under development.

As will be appreciated by one skilled in the art, the present disclosure may be embodied at least as a method, apparatus or computer program product. Accordingly, the present disclosure may take the form of an entirely hardware embodiment, an entirely software embodiment (including firmware, resident software, micro-code, etc.) or an embodiment combining software and hardware aspects.

The present disclosure is disclosed herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which executes via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Therefore, in accordance with a further embodiment, is proposed a computer program product capable of providing for generating a traceability matrix document regarding a system under development. Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A computer program product in accordance with various embodiments comprises a tangible computer usable medium including a computer usable program code for generating a traceability matrix document regarding a system under development, the computer usable program code being used for providing input information regarding the system under development to a processing framework, processing the input information by the processing framework, and automatically creating a traceability matrix document regarding the system under development from the input information.

Accordingly, the disclosed embodiments present a method, an apparatus and a computer program product for defining a safety-oriented requirements specification for a technical system. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

In addition, the flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of generating a traceability matrix document regarding a system under development, comprising:
providing input information regarding the system under development to a processing framework;
processing said input information by said processing framework, and
automatically creating a traceability matrix document regarding the system under development from said input information.

2. The method according to claim 1, wherein said input information is provided via video media.

3. The method according to claim 2, further comprising the step of annotating said video media.

4. The method according to claim 1, wherein said input information regarding the system under development defines the components of the system under development needed for the generation of the traceability matrix document regarding the system under development.

5. The method according to claim 1, wherein said input information comprises both early system requirements information and high-level system requirements information.

6. The method according to claim 1, wherein the step of processing said input information comprises extracting at least one of a plurality of requirements traces from said annotated video media, a plurality of requirements regarding the system under development, and the identification of a plurality of objects of interest comprised by the system under development.

7. The method according to claim 3, wherein the step of processing said input information presented as video media comprises the identification in said video media of at least a scene of interest, and the identification of a plurality of frames of interest within said identified scene.

8. The method according to claim 3, wherein the step of processing said input information presented as video media further comprises identifying in said plurality of frames of interest a plurality of objects of interest, and wherein said frames of interest each comprise a diagram.

9. The method according to claim 8, wherein said diagram is at least one of a requirements model diagram (UML diagram), a system requirements diagram, or a combination of the two diagrams.

10. The method according to claim 9, wherein the step of processing said input information presented as video media further comprises identifying a plurality of traces between the identified plurality of objects of interest in said frame of interest.

11. The method according to claim 1, wherein the step of automatically creating a traceability matrix document involves processing at least one of plurality of requirements traces from said annotated video media, a plurality of requirements regarding the system under development, and a plurality of objects comprised by the system under development.

12. The method according to claim 1, further comprising extracting a plurality of requirements models for the objects located in a frame of interest.

13. The method according to claim 12, further comprising mapping the extracted components of said input information to create the traceability matrix document regarding the system under development.

14. An apparatus for generating a traceability matrix document regarding a system under development, comprising:
means for providing input information regarding the system under development to a processing framework;
means for processing said input information by said processing framework, and
means for automatically creating a traceability matrix document regarding the system under development from said input information.

15. The apparatus according to claim 14, wherein said input information is provided via video media.

16. The apparatus according to claim 14, wherein said input information regarding the system under development defines the components of the system under development needed for the generation of the traceability matrix document regarding the system under development.

17. The apparatus according to claim 14, wherein said input information comprises both early system requirements information and high-level system requirements information.

18. The apparatus according to claim 14, wherein processing said input information comprises extracting at least one of a plurality of requirements traces from said annotated video media, a plurality of requirements regarding the system under development, and the identification of a plurality of objects of interest comprised by the system under development.

19. The apparatus according to claim 15, wherein processing said input information presented as video media comprises the identification in said video media of at least a scene of interest, and the identification of a plurality of frames of interest within said identified scene.

20. A computer program product, comprising:
a tangible computer usable medium storing a computer usable program code for generating a traceability matrix document regarding a system under development, wherein the computer usable program code when executed on a computer provides for:
providing input information regarding the system under development to a processing framework;
processing said input information by said processing framework, and
automatically creating a traceability matrix document regarding the system under development from said input information.
